(19) United States
(12) Patent Application Publication
(10) Pub. No.: US 2020/0070085 A1
(43) Pub. Date: Mar. 5, 2020

(54) IMPROVED USE OF THE RESIDUAL GAS FROM A PRESSURE SWING ADSORPTION PLANT

(71) Applicant: Linde Aktiengesellschaft, Munich (DE)

(72) Inventors: Werner LEITMAYR, Neuburg/Donau (DE); Tobias KELLER, Feldkirchen-Westerham (DE); Florian HANG, Berg (DE); Alexander MAIER, Holzkirchen (DE)

(73) Assignee: Linde Aktiengesellschaft, Munich (DE)

(21) Appl. No.: 16/610,140

(22) PCT Filed: Apr. 27, 2018
(86) PCT No.: PCT/EP2018/000226

§ 371 Date: Nov. 1, 2019

(30) Foreign Application Priority Data
May 4, 2017 (DE) 10 2017 004 326.4

(51) Int. Cl. B01D 53/053; C01B 3/34; C01B 3/56

(52) U.S. Cl. CPC B01D 53/053; C01B 3/34; C01B 3/56; C01B 2203/1685; B01D 2259/40086; C01B 2203/0233; C01B 2203/043; B01D 2256/16

(57) ABSTRACT

The invention relates to a process for providing a fuel gas (4) which is generated at regeneration pressure as residual gas (3) during the regeneration of a pressure swing adsorption plant (D) used for fractionation of synthesis gas (1) and after an intermediate storage in a buffering vessel (P) is passed through a control valve (Z1) in order to be passed to a burner (B) with a controlled mass flow. The characterizing feature here is that by specification of a manipulated variable (8) determined by the load on the pressure swing adsorption plant (D) the control valve (Z1) is positioned at an operating point wherein the pressure in the buffering vessel (P) is in a defined range.

The invention relates to a process for providing a fuel gas which during regeneration of a pressure swing adsorption plant used for fractionation of synthesis gas is obtained as residual gas at regeneration pressure and after intermediate storage in a buffering vessel is passed through a control valve to be supplied to a burner at a controlled mass flow.

Pressure swing adsorption plants (referred to hereinbelow as PSA for short) are used for example to generate high-purity hydrogen, wherein a hydrocarbon-containing starting material is converted into a hydrogen-containing synthesis gas in a burner-fired steam reformer. Obtained from the synthesis gas in subsequent process steps is crude hydrogen which while largely consisting of hydrogen does still contain significant amounts of impurities such as carbon monoxide and methane. In order to remove the impurities the crude hydrogen is sent to the PSA where it flows at elevated pressure through one of a plurality of adsorbers which are each filled with an adsorber material which adsorbs and retains the impurities present in the crude hydrogen while allowing the hydrogen to pass through largely unhindered. The hydrogen exiting the adsorber therefore has a high purity of typically more than 99.99 vol %.

Since the adsorption capacity of the adsorber material for the impurities is limited the crude hydrogen stream into the absorber must be interrupted after a certain time before the purity of the exiting hydrogen is impaired. While the crude hydrogen is diverted to another adsorber of the PSA having adsorber material which is still capable of absorption, the adsorber laden with impurities is regenerated. To this end the pressure in the adsorber is reduced to the so-called regeneration pressure to desorb the adsorbed impurities from the adsorber material. In order that the impurities are removed as completely as possible the adsorber is purged during and/or after the pressure reduction with a regeneration gas which is usually pure hydrogen obtained in the PSA. A lower regeneration pressure makes it possible to use less regeneration gas to desorb the same amount of impurities.

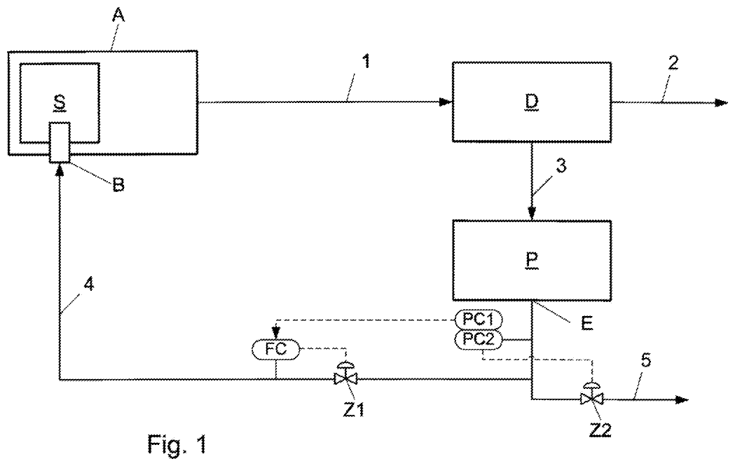

The gas mixture obtained during the adsorber regeneration, referred to as residual gas, consists predominantly of flammable substances and is therefore normally used as fuel gas for firing the steam reformer. Since both the mass flow and the composition of the residual gas vary significantly with time it is passed from the PSA initially into a buffer vessel from which it is withdrawn again in a largely homogenized state and supplied to the steam reformer. Without increasing the residual gas pressure, as proposed for instance in German patent DE19955676, the minimum value for the regeneration pressure of the adsorbers is determined by the pressure in the buffering vessel which according to the prior art is controlled to a set target value of not less than 300 mbar(g). A control concept employed therefor shall be more particularly elucidated with reference to FIG. 1.

From hydrogen generator A the crude hydrogen 1 separated from a synthesis gas generated in a burner-fired steam reformer S is passed to pressure swing adsorption plant D to obtain pure hydrogen 2 and a residual gas 3 which is intermediately stored in a buffering vessel P. The pressure in the buffering vessel P is kept largely constant at a value of about 300 mbar(g) by the pressure controller PC1. In case of impairment of the residual gas inflow 3 due to a failure there is thus always a sufficiently large residual gas amount in the buffering vessel P to be able to bridge the time until substitution of the residual gas by a fuel gas from an external source. To keep constant the pressure in the buffering vessel P, the pressure controller PC1 alters the target value for the flow controller FC which then further opens or closes the control valve Z1, which is normally a control flap, arranged in the fuel gas line 4 and thus decreases or increases the pressure drop of the fuel gas to correspondingly increase or decrease the fuel gas flow. To avoid short-duration pressure variations in the timescale of seconds, such as regularly occur upon switching between the individual absorbers of the PSA D, from resulting in undesired variations in the control circuit, the flow controller FC is set with very slow control parameters so that only long-term trends are compensated and the position of the control valve Z1 practically only changes in case of changes in the load on the steam reformer S while remaining largely unchanged in case of constant normal operation. Especially short-duration pressure variations in the buffering vessel P are therefore transmitted without substantial attenuation to the burners B and thus into the combustion space of the steam reformer S. These pressure variations in the combustion space are a frequent cause of safety-related furnace shutdown. Not least in the case of plant failures that occur, the slow control parameters of the flow controller FC prevent an efficient and rapid control intervention.

The system is protected from excessive pressure increases by the flare controller PC2 which opens the control valve Z2 immediately and passes residual gas 5 to a flare (not shown) as soon as the pressure in the buffering vessel P exceeds a target value by typically more than 50 mbar.

If the plant is run at subcapacity the residual gas amount 3 suppliable to the burner system B falls and the pressure drops over the fixed resistances in the fuel gas conduit 4 between the buffering vessel P and the steam reformer S are reduced correspondingly. In order that the residual gas pressure in the buffering vessel P can be kept constant even under these conditions the flow resistance of the control valve Z1 must be increased which is effected by shifting the operating point toward the closed position. In this position the correlation between position change and flow change is markedly nonlinear so that even minimal spontaneous position changes of the control valve Z1 result in considerable changes in the fuel gas stream 4 and pressure variations in the combustion space, which in turn can result in shutdown of the burner system B and thus in an interruption of hydrogen generation.

Reducing the pressure in the buffering vessel P compared to the prior art does make it possible to reduce the regeneration pressure of the PSA D and to increase the pure hydrogen yield on account of the then lower demand for regeneration gas. However, this results in a reduction of the stored gas amount and—on account of the lower buffering pressure—greater relative pressure variations. Enlarging the buffering vessel can counteract this but increases capital costs for the plant and makes the hydrogen generation less economic.

The present invention accordingly has for its object to provide a process of the type in question which makes it possible to overcome the difficulties encountered upon reducing the regeneration pressure in accordance with the prior art.

The recited object is achieved according to the invention when the control valve is positioned at an operating point by input of a manipulated variable determined from the load on the pressure swing adsorption plant, wherein the pressure in the buffering vessel is in a defined range.

An operating point is to be understood as meaning a position of the control valve in which the fuel gas flows from the buffering vessel to the burner at a mass flow corresponding to the load on the PSA and the pressure drop over the control valve which for control purposes is varied around the operating point is in a range which allows trouble-free execution of the control task.

To determine the manipulated variable for the control valve the load on the PSA is measured at time intervals normally in the seconds range and averaged over a plurality of consecutive measured values. Between two consecutive load determinations the manipulated variable remains unchanged independently of the actual load on the PSA. In order to be able to compensate short-duration pressure variations of the residual gas in the range of seconds, the control valve which is preferably in the form of a control flap and provided with remote operation and position feedback is advantageously controlled via a flow rate controller set with correspondingly fast control parameters.

To determine the load on the PSA the current residual gas amount may be determined and for example compared to the residual gas amount at nominal load. Since direct measurement of the residual gas amount is normally possible only with considerable errors, the current residual gas amount is advantageously not measured directly but rather calculated from the amount of synthesis gas arriving at the PSA and the known yield of the PSA. However, it is preferable to determine the PSA load by determining the amount of the synthesis gas arriving at the PSA and comparing it to the synthesis gas amount at nominal load.

The manipulated variable is preferably input to the control valve such that over the entire load range of the PSA a pressure is established in the buffering vessel whose temporal average is less than in the prior art, thus resulting in a reduction of the regeneration pressure of the PSA compared to the prior art. The temporal average value of the pressure is preferably between 100 and 250 mbar(g).

The correlation between the load on the PSA and the manipulated variable for the control valve is characteristic for the production plant of which the PSA forms part. Said correlation must be determined experimentally or by simulation and is preferably recorded as a curve or table, electronically or otherwise.

The size and position of the defined range in which the pressure in the buffering vessel may vary likewise depend on the characteristics of the production plant and the operating conditions thereof and are specific to the system. They are chosen such that stable plant operation is ensured as long as the pressure in the buffering vessel is in the defined range. Especially when the synthesis gas to be fractionated is generated in a burner-fired steam reformer which uses the residual gas for heating, the lower limit of the defined pressure range is between 50 and 150 mbar(g) and the upper limit is between 200 and 300 mbar(g).

The process according to the invention makes it possible to achieve hydraulic balance of the controlled system between the outlet of the buffering vessel and the opening into the burner over the entire load range on the PSA. The hydraulic balancing is preferably performed such that the maximum pressure drop over the control valve is less than 70%, and particularly preferably less than 50%, of the total pressure drop over the controlled system. Short pressure variations in the buffering vessel in the range of seconds, such as occur for instance when switching between the adsorbers of the PSA, may therefore be efficiently compensated even in the lower PSA load range for example via a flow controller acting on the control valve and operated with markedly faster control parameters than in the prior art. This has not hitherto been possible in a concept according to the prior art since the high pressure drop over the control valve causes severe disruption to the system even for small position changes especially when operated at low load.

At its particular operating point the control valve advantageously has sufficient distance to its end positions over the entire load range on the PSA. In order especially to ensure sufficient scope for interventions of a flow controller used for compensation of short-duration pressure variations in the buffering vessel, the control valve is preferably 70% to 90% open at its operating point at full load operation, wherein the pressure in the buffering vessel is about 30 to 50 mbar from the upper end of the defined range. During operation at minimal load the pressure in the buffering vessel is 30 to 50 mbar from the lower end of the defined range and the control valve is 20% to 40% open.

Provided it does not deviate from the defined pressure range, the pressure in the buffering vessel is not a responding variable. At least for an unchanged load on the PSA the control valve remains at its operating point under these conditions. Only when the pressure reaches the limits of the defined range do additional high pressure and low pressure controllers become active.

The proposed process may be realized in different ways. Preferably, the position of the control valve is altered via a flow controller coupled to a position analysis controller. The position analysis controller which is input with the operating point dependent on the load on the PSA and derived from the recorded curve or table as the manipulated variable compares said manipulated variable with the actual position value for the control valve and from the deviation of the two values determines a target value for the flow controller. If the operating point for the control valve is smaller than the actual position value, i.e. the control valve is opened further than required, the currently applicable target value for the full controller is reduced so that the control valve moves in the closing direction. If, by contrast, the position analysis reveals that the control valve is currently in an excessively closed position, the flow controller is input with a higher target value, thus causing the control valve to be opened further. The flow controller is also used to compensate short-duration pressure variations in the buffering vessel, for which purpose it is set with markedly faster control parameters than the position analysis controller.

Another option is that of dispensing with the position analysis controller and instead controlling the flow controller via a pressure controller which monitors the pressure in the buffering vessel and which is input with its target value from the recorded curve or table according to the current load on the PSA as a manipulated variable. The target value for the pressure controller may also be determined via a load-dependent calculation which uses for example the desired pressure drop over the control valve as an input.

In order that the pressure in the buffering vessel can be kept in a limited range under any operating condition of the plant, especially in exceptional operational cases and in cases of disruption, the use of a high pressure controller and a low pressure controller is proposed.

If the pressure in the buffering vessel exceeds the upper limit of the defined pressure range, the high pressure controller opens a conduit through which residual gas may be discharged from the buffering vessel. The high pressure controller keeps the conduit open until the pressure in the buffering vessel has once again fallen below the upper limit of the defined pressure range. It is preferable when the conduit is a connection conduit to a flare in which the residual gas discharged from the buffering vessel is disposed of by incineration.

Especially when the PSA is under partial load the buffering vessel is operated at a pressure only slightly above atmospheric pressure and a correspondingly reduced storage efficiency. To ensure that the buffering vessel may be advantageously utilized as a storage means under any operating condition it is therefore provided that a low pressure controller opens a conduit by means of which a flammable gas is introduced into the buffering vessel as soon as the pressure of the residual gas falls below the lower limit of the defined pressure range. The low pressure controller keeps the conduit open until the pressure in the buffering vessel once again exceeds the lower limit of the defined pressure range. This conduit is preferably a bypass conduit by means of which synthesis gas or a gas mixture obtained by fractionation of synthesis gas, for example crude hydrogen, is diverted upstream of the PSA and introduced into the buffering vessel in bypass to said PSA. The direct supply of synthesis gas/crude hydrogen into the buffering vessel makes it possible to utilize the entirety of the residual gas present in the buffering vessel in case of disruption in the PSA and consequent interruption of the residual gas supply. This has the result that compared to the prior art a significantly longer time is available for provision of a substitute gas from an external fuel gas source.

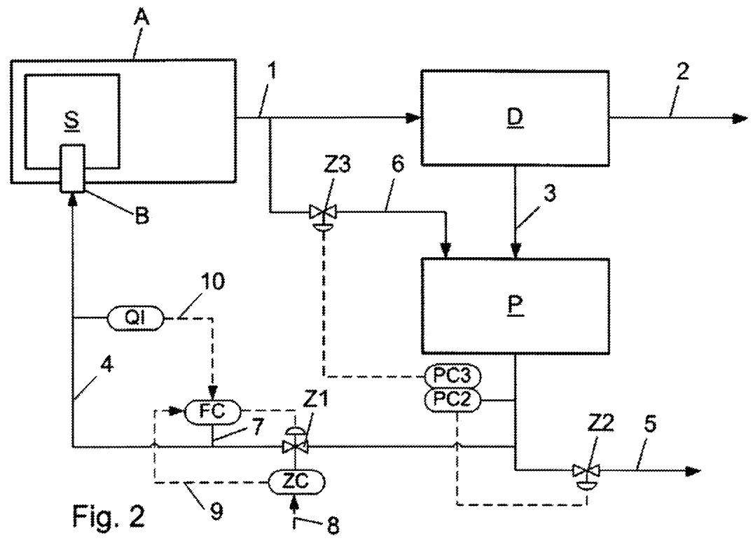

The invention shall be more particularly elucidated hereinbelow with reference to an exemplary embodiment illustrated schematically in FIG. 2.

FIG. 2 shows a production plant for hydrogen having a burner-fired steam reformer for generating synthesis gas and a pressure swing adsorption plant whose residual gas is used for heating the steam reformer according to a preferred variant of the invention. Identical plant parts and material streams as in FIG. 1 are provided with identical reference numerals.

From the steam generator A fitted with a burner-fired steam reformer S, the crude hydrogen 1 separated from a synthesis gas is passed to a pressure swing adsorption plant D to obtain pure hydrogen 2 and a residual gas 3 which is intermediately stored in buffering vessel P and subsequently supplied to the burners B of the steam reformer S as fuel gas 4.

To control the fuel gas stream 4 the position of the control valve Z1 is in normal operation of the plant altered via the flow controller FC which is coupled to a position analysis controller ZC. To achieve a higher precision the actual value 7 for the fuel gas flow may be corrected with the current fuel gas density 10 which is determined using the density analyzer Q1. The position analysis controller ZC which is input with the operating point for the control valve Z1 which is dependent on the load on the pressure swing adsorption plant D and derived from a recorded curve or table as the manipulated variable 8 compares said manipulated variable with the actual position value for the control valve Z1 and from the deviation of the two values determines a target value 9 for the flow controller FC. If the operating point for the control valve Z1 is smaller than the actual position value, i.e. the control valve Z1 is opened further than required, the currently applicable target value for the flow controller FC is reduced so that the control valve Z1 moves in the closing direction. If, by contrast, the position analysis reveals that the control valve Z1 is currently in an excessively closed position, the flow controller FC is input with a higher target value, thus causing the control valve Z1 to be opened further. The flow controller FC is set with fast control parameters so that it is capable of compensating flow variations of the fuel gas 4 caused by short-duration pressure variations in the buffering vessel P. In normal operation the pressure in the buffering vessel P is not a responding variable and may vary freely in a defined range which preferably extends between 100 and 250 mbar(g).

In order to keep the pressure in the buffering vessel P in the defined range in any operating condition, especially in exceptional cases and in case of disruption, the plant comprises a high pressure controller PC2 and a low pressure controller PC3.

If the pressure in the buffering vessel P exceeds the upper limit of the defined pressure range, the high pressure controller PC2 opens the shutoff element Z2 so that residual gas can flow out of the buffering vessel P via the flare conduit 5 to a flare (not shown) where it is disposed of by incineration. The high pressure controller PC2 keeps the flare conduit 5 open until the pressure in the buffering vessel P has once again fallen below the upper limit of the defined pressure range.

If the pressure in the buffering vessel P falls below the lower limit of the defined pressure range, the low pressure controller PC3 opens the shutoff element Z3 so that crude hydrogen 1 is introduced directly into the buffering vessel P via the conduit 6 in bypass to the pressure swing adsorption plant D. The low pressure controller PC3 keeps the conduit 6 open until the pressure in the buffering vessel P once again exceeds the lower limit of the defined range or a substitute gas for the residual gas 3 is provided from an external source.

1. A process for providing a fuel gas (4) which during regeneration of a pressure swing adsorption plant (D) used for fractionation of synthesis gas (1) is obtained as residual gas (3) at regeneration pressure and after intermediate storage in a buffering vessel (P) is passed through a control valve (Z1) to be supplied to a burner (B) at a controlled mass flow, characterized in that the control valve (Z1) is positioned at an operating point by input of a manipulated variable (8) determined from the load on the pressure swing adsorption plant (D), wherein the pressure in the buffering vessel (P) is in a defined range.

2. The process as claimed in claim 1, characterized in that the manipulated variable (8) is input to the control valve (Z1) such that over the entire load range of the pressure swing adsorption plant (D) a pressure is established in the buffering vessel (P) whose temporal average is less than 300 mbar(g).

3. The process as claimed in claim 1, characterized in that the lower limit of the defined pressure range is between 50 and 150 mbar(g) and the upper limit is between 200 and 300 mbar(g).

4. The process as claimed in claim 1, characterized in that the control valve (Z1) is positioned at its operating point via a flow controller (FC) coupled to a position analysis controller (ZC), for which purpose by comparison of the actual position value for the control valve (Z1) with the load-dependent manipulated variable (8) the position analysis controller (ZC) determines a value which it inputs to the flow controller (FC) as a target value.

5. The process as claimed in claim 1, characterized in that the control valve (Z1) is positioned at its operating point via a flow controller (FC) coupled to a pressure controller (PC1), for which purpose by comparison of the pressure in the buffering vessel (P) with the load-dependent manipulated variable (8) the pressure controller (PC1) determines a target value which it inputs to the flow controller (FC).

6. The process as claimed in claim 1, characterized in that the control valve (Z1) is positioned at its operating point via a flow controller (FC) coupled to a pressure controller (PC1), for which purpose the pressure controller (PC1) obtains a target value calculated as a function of load.

7. The process as claimed in claim 1, characterized in that the burner (B) is used for firing a steam reformer (S).

8. The process as claimed in claim 1, characterized in that the pressure swing adsorption plant (D) is used for removal of hydrogen (2) from a synthesis gas obtained in a steam reformer (S).

9. The process as claimed in claim 8, characterized in that synthesis gas or a gas mixture (1) obtained by fractionation of synthesis gas is diverted upstream of the pressure swing adsorption plant (D) and passed directly into the buffering vessel (P) in bypass to said plant as soon as the pressure in the buffering vessel (P) falls below the lower limit of the defined pressure range.
